(19) United States
(12) Patent Application Publication
(10) Pub. No.: US 2015/0324435 A1
(43) Pub. Date: Nov. 12, 2015

(54) METHODS AND SYSTEMS TO IDENTIFY QUERY RECOMMENDATONS

(71) Applicant: Chu-Cheng Hsieh, San Jose, CA (US)

(72) Inventor: Chu-Cheng Hsieh, San Jose, CA (US)

(21) Appl. No.: 14/706,792

(22) Filed: May 7, 2015

Related U.S. Application Data
(60) Provisional application No. 61/991,093, filed on May 9, 2014.

(51) Int. Cl. G06F 17/30

(52) U.S. Cl. CPC G06F 17/30554; G06F 17/30864; G06F 17/3064

(57) ABSTRACT

In various example embodiments, systems and methods to identify query recommendations are presented. The system receives a query from a device and associates the query with query recommendations. Next, the system generates a probability distribution for each of the query recommendations based on experimental information associated with each of the query recommendations. Then the system samples each of the probability distributions to identify a probability for each the corresponding query recommendations. The probabilities indicate the likelihood of the corresponding query recommendation being selected. Next, the system identifies displayable query recommendations based on the probabilities for each of the corresponding query recommendations. The system then communicates an interface to the device that includes the query and the displayable query recommendations. Finally, the system updates the experimental information associated with each of the displayable query recommendations responsive to identifying whether one of the displayable query recommendations was selected.

### RELATED APPLICATIONS

This application claims the priority benefit of U.S. Provisional Application No. 61/991,093 entitled “Methods and Systems to Efficiently Identify Searcy Query Recommendations,” filed May 9, 2014, which is hereby incorporated herein by reference in its entirety.

### TECHNICAL FIELD

Embodiments of the present disclosure relate generally to data processing and, more particularly, but not by way of limitation, to methods and systems to identify query recommendations.

### BACKGROUND

Many systems respond to receipt of a query of a database by communicating a set of one more query recommendations. The query recommendations may be presented to the user in a box below the query while the system waits for a response from the user. The user may respond by selecting one of the query recommendations for processing by the system as the new query, type a new query, or enter the existing query. Meaningful query recommendations may improve the efficiency of a system because the user is relieved of the burden of thinking of or typing the query.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a system to identify query recommendations, according to an embodiment;

FIG. 2A is a diagram illustrating a probability distribution graph, according to an embodiment;

FIG. 2B is a diagram illustrating a probability distribution graph, according to an embodiment;

FIG. 2C is a diagram illustrating a probability distribution presentation, according to an embodiment;

FIG. 3 is pseudo-code for updating failure and success sums, according to an embodiment;

FIG. 4A is block diagram illustrating query information, according to an embodiment;

FIG. 4B is block diagram illustrating query data, according to an embodiment;

FIG. 4C is block diagram illustrating query suggestion information, according to an embodiment;

FIG. 4D is block diagram illustrating experimental information, according to an embodiment;

FIG. 5A is block diagram illustrating a new query message, according to an embodiment;

FIG. 5B is block diagram illustrating a recommendation selected message, according to an embodiment;

FIG. 5C is block diagram illustrating a recommendation not-selected message, according to an embodiment;

FIG. 6 is block diagram illustrating configuration information, according to an embodiment;

FIG. 7 is flow diagram illustrating a method, according to an embodiment, to identify query recommendations;

FIG. 8 is flow diagram illustrating a method, according to an embodiment, to update experimental information;

FIG. 9 is a block diagram illustrating an example of a software architecture that may be installed on a machine, according to some example embodiments; and

FIG. 10 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

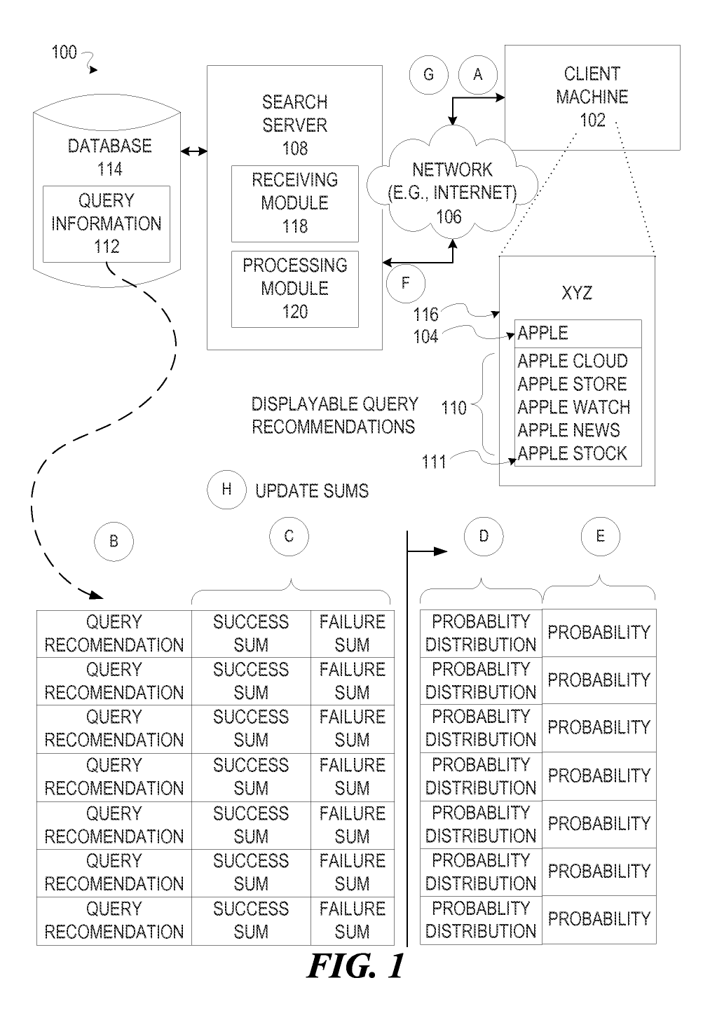

FIG. 1 is a block diagram illustrating a system 100 to identify query recommendations, according to some example embodiments. The system 100 may include a client machine 102 (e.g., smart phone such as an iPhone or Android or desktop device such as an iMac Desktop Computer, etc.) that receives a query including one or more keywords (e.g., “APPLE”) or images in an input box 104 and communicates the query over a network 106 to a search server 108 that, in turn, processes the query to identify displayable query recommendations 110 (one or more keywords or images) based on experimental information respectively associated with each of a set of displayable query recommendations 110 that is retrieved from a database 114. Further, the system responds to the query by communicating a user interface 116 back over the network 106 to the client machine 102, with the user interface 116 including the query, “APPLE,” in the input box 104 and the query recommendations including “APPLE CLOUD,” “APPLE STORE.” “APPLE WATCH,” “APPLE NEWS,” and “APPLE STOCK,” in a query recommendation box 111. The user may respond to a presentation of the user interface 116 by selecting one of the displayable query recommendations 110 from the query recommendation box 111 or not. The system 100 may respond to an identification of a selection of a displayable query recommendation 110 by registering a success for the displayable query recommendation 110 that was selected. The system 100 may respond to an identification of non-selected displayable query recommendations 110 by registering failures for the displayable query recommendations 110 that were not selected. For example, a user may ignore all of the displayable query recommendations 110 by typing another query into the input box 104, and the system may respond by registering failures for all of the displayable query recommendations 110. The search server 108 may register success or failure by updating experimental information (e.g., success sum, failure sum) associated with each of the displayable query recommendations in the query information 112 in the database 114. For example, selection of a displayable query recommendation 110 may be registered as a success by increasing the success sum associated with the displayable query recommendation 110, as described later in this document. On the other hand, identification of a non-selected displayable query recommendation 110 may be registered as a failure by increasing the failure sum associated with the non-selected displayable query recommendation 110, also as described later in this document. Accordingly, the system 100 may collect experimental information in real-time and harvest the experimental information in real time for the purpose of intelligently selecting displayable query recommendations that are consistent with goals.

The identification of displayable query recommendations 110 based on experimental information enables an achievement of competing goals. That is, exploitation of query recommendations that are known to be successful (e.g., selected) may be balanced with an exploration of query recommendations that are of unknown value. Such an approach is further sensitive to discover preferences of users that change over time because the collection of experimental information (e.g., success sums and failure sums) is performed and harvested in real-time. Further, the approach described below may be adapted to balance exploration/exploitation goals to accommodate users with mobile devices that typically have small display screens and small keyboards. For example, mobile devices with small display screens are capable of displaying only a few query recommendations. Also, for example, mobile devices with keyboards that are small tend to impede typing. Accordingly, users who operate mobile devices may be biased towards exploitation rather than exploration when compared with users who operate stationary devices with larger display screens and keyboards.

The system 100 to identify query recommendations, according to some example embodiments, is now described in greater detail. At operation “A,” a receiving module 118, at the search server 108, may receive a query (e.g., “APPLE”) over the network 106 via the input box 104 on the client machine 102 (e.g., mobile device, smartphone). At operation “B.” a processing module 120 may associate the query with at least one query recommendation in the query information 112 in the database 114. At operation “C,” the processing module 120 may utilize the experimental information (e.g., success sums and the failure sums) associated with each query recommendation in the query information 112 to generate probability distributions for the query recommendations. For example, the processing module 120 may generate a probability distribution based on a success sum, a failure sum, and an experimental sum (not shown) respectively associated with each of the query recommendations. At operation “D,” the processing module 120 may sample each of the probability distributions to identify a probability corresponding to each of the query recommendations. The probabilities respectively indicate the likelihood of the corresponding query recommendation being selected. At operation “E,” the processing module 120 may identify displayable query recommendations for display in the query recommendation box 111 from all of the query recommendations in the query information 112. For example, the processing module 120 may sort the probabilities associated with each of the query recommendations from highest to lowest and select the top highest probabilities up to a value (e.g., maximum number of displayable query recommendations). For example, the user interface 116 on the client machine may be associated with a maximum number of displayable query recommendations of five. Accordingly, the top five probabilities are utilized to identify the top five displayable query recommendations for display in the query recommendation box 111. At operation “F,” the processing module 120 may communicate the user interface 106 to the client machine 102. For example, the user interface 116 may include the query, “APPLE,” in the input box 104 and the query recommendations including “APPLE CLOUD,” “APPLE STORE,” “APPLE WATCH,” “APPLE NEWS,” and “APPLE STOCK,” in the query recommendation box 111. In another embodiment, the processing module 120 may communicate data to the client that is rendered into a user interface at the client machine 102. For example, the client machine 102 may include a mobile device that includes an “app” that receives the data and generates a user interface or updates a user interface. At operation “G,” the receiving module 118 may receive an event from the client machine 102 indicating whether or not a displayable query recommendation 110 was selected and, if selected, the event may identify the displayable query recommendation 110 that was selected. At operation “H,” the processing module 120 may update the experimental information associated with each of the displayable query recommendations 110 based on the event. Selection of a displayable query recommendation 110 may be registered as a success by adding a value to the success sum for the displayable query recommendation 110 in the query information 112. Non-selection of displayable query recommendations 110 may be registered as failures by adding a value to the failure sums for the respective displayable query recommendations 110 in the query information 112. Finally, an experimental sum may be incremented by one for each presentation of a query recommendation.

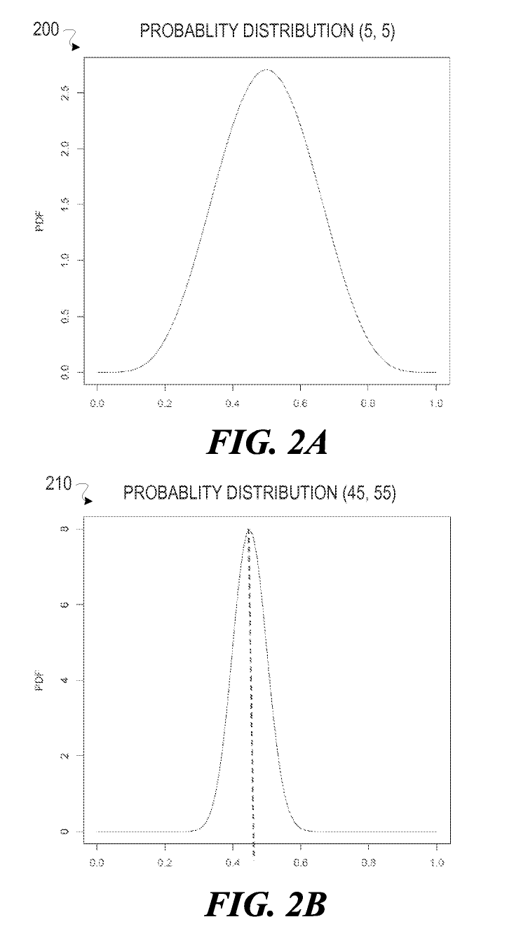

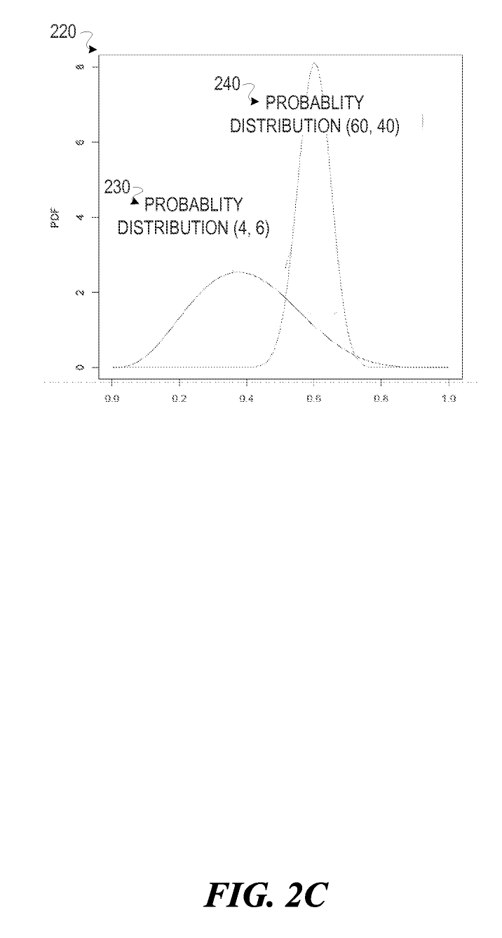

FIG. 2A is a diagram illustrating a probability distribution graph 200, according to an embodiment. The probability distribution graph 200 may be generated and sampled by the processing module 120 to identify query recommendations. The probability distribution graph 200 illustrates “10” (e.g., 5+5) experiments were performed for a query-query recommendation pair. For example, the probability distribution graph 200 may illustrate a query-query recommendation pair “APPLE”-“APPLE CLOUD” (not shown) with a success sum of “5” and a failure sum of “5.” That is, the query recommendation “APPLE CLOUD” is illustrated as being selected in “5” of the “10” experiments and not being selected in “5” of the “10” experiments. The X axis plots a probability that corresponds to a success (e.g., the likelihood of being selected from the query recommendation box 111) and the “Y” axis plots a frequency measure (e.g., probability density function (PDF)) for the corresponding sampled probability at “X.” For example, a probability of “0.5” is illustrated in the probability distribution graph 200 as being associated with a frequency measure of “2.6” and the probability of “0.2” is illustrated in the probability distribution graph 200 as being associated with a frequency measure of “0.25.” In other words, the processing module 120 is “10.4” (e.g., “2.6”/“0.25”) times more likely to sample the probability of “0.5” than the probability “0.25.”

FIG. 2B is a diagram illustrating a probability distribution graph 210, according to an embodiment. The probability distribution graph 210 may be generated and sampled by the processing module 120 to identify displayable query recommendations 110. The probability distribution graph 200 illustrates “100” (e.g., 45+55) experiments were performed for a query-query recommendation pair. For example, the probability distribution graph 210 may illustrate a query-query recommendation pair “APPLE”-“APPLE CLOUD” with a success sum of “45” and a failure sum of “55.” That is, the query recommendation “APPLE CLOUD” is indicated as being selected in “45” of the “100” experiments and not being selected in “55” of the “100” experiments. It will be appreciated that the “100” experiments of exploring the query recommendation “APPLE CLOUD” being presented with the query “APPLE” yields information that may be exploited. For example, in comparing FIG. 2A with FIG. 2B, the probability of “0.45” is now associated with an “8.0” frequency measure. Accordingly, the “5” probability, as illustrated in FIG. 2B, is now approximately “3.08” (“8.0”/“2.6”) times more likely to be sampled than the “0.5” probability illustrated in FIG. 2A. In comparing FIG. 2A and FIG. 2B, it will be appreciated that learning reshapes probability distributions that, in turn, determine a probability that is resampled that, in turn, determines a set of query recommendations that are selected for display in the query recommendation box 111. It will further be appreciated that probability distributions for each query-query recommendation pair may be continually updated in real-time or updated in batch mode at predetermine intervals to increase performance. It will further be appreciated that probability distributions for each query-query recommendation pary may be updated over time through seasonal phenomena. For example, the probability distribution of a query recommendation that is seasonal (e.g., “Easter Bunnies”) may be dynamic (e.g., changing over time) and dropping off precipitously after a specific date (e.g., “Easter”).

FIG. 2C is a graph illustrating a probability distribution presentation 220, according to an embodiment. The probability distribution presentation 220 includes a probability distribution graph 230 and a probability distribution graph 240. The probability distribution graph 230 illustrates “10” experiments for a query-query recommendation pair “APPLE”-“APPLE CLOUD” with a success sum of “4” and a failure sum of “6.” The probability distribution graph 240 illustrates “100” experiments for a query-query recommendation pair “APPLE”-“APPLE CLOUD” with a success sum of “60” and a failure sum of “40.”

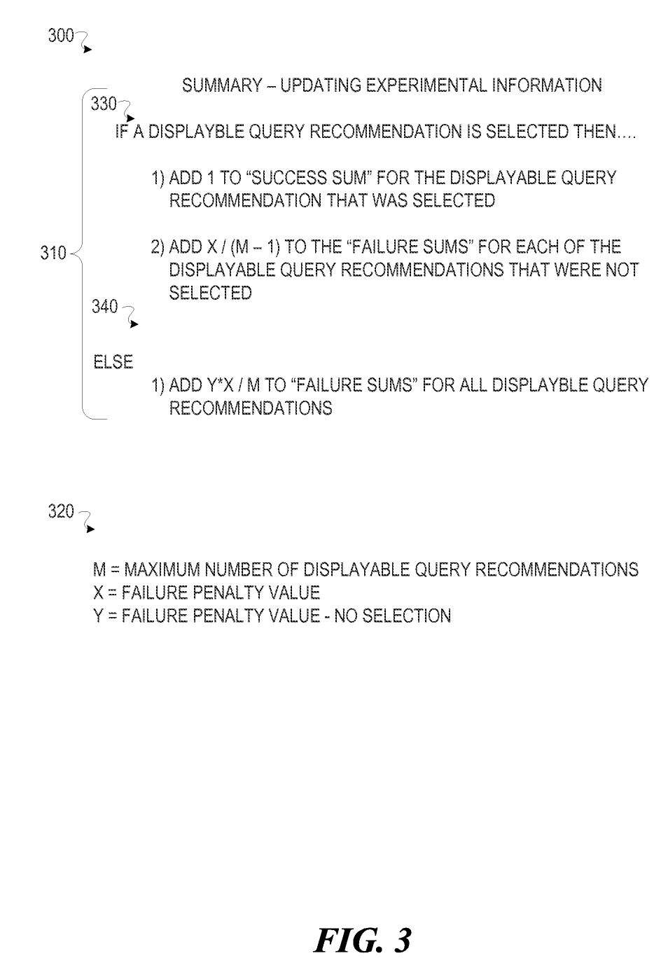

FIG. 3 is a summary 300, according to an embodiment, for updating experimental information (e.g., failure sums and success sums). The summary 300 includes pseudo-code 310 for updating failure and success sums in the query information 112 in the database 114 and definitions 320 of configurable parameters included in the pseudo-code 310. The definitions 320 define the variables “M,” “X,” and “Y,” which may be predetermined or configured dynamically responsive to processing a query.

“M” is a maximum number of displayable query recommendations 110 that are displayed in the query recommendation box 111. “M” is an integer (e.g., 0-10). In some embodiments, “M” may be a small value to accommodate the screens of mobile devices with little space to display query recommendations 110. In some embodiments, “M” may be a large value to accommodate stationary devices (e.g., desktop computers) with large monitors. In some embodiments, “M” may be configured globally for all devices. In some embodiments, “M” may be configured based on a device or a type of device that is communicating with the search server 108.

“X” is a failure penalty value. “X” is utilized in the pseudo-code 310 to update failure sums associated with query recommendations. “X” may be configured to minimize the penalty for failure or to maximize the penalty for failure. Minimizing “X” enhances exploration and diminishes exploitation. In some embodiments, “X” may be minimized to accommodate stationary devices (e.g., desktop computer) with large monitors and ergonomic keyboards. Alternatively, maximizing “X” enhances exploitation and diminishes exploration. In some embodiments, “X” may be maximized to accommodate mobile devices (e.g., smartphone) with small monitors and small keyboards. In some embodiments, “X” may be globally configured as a predetermined single value for all devices. In other embodiments, “X” may be dynamically configured in real-time in accordance with a device or a type of device that is communicating the query to the search server 108. In some embodiments “X” may be an integer. In other embodiments “X” may be real number. In some embodiments “X” may not be included in pseudo-code 310. Accordingly, the non-selection summary pseudo-code 340 may be computed solely as “Y/M.”

“Y” is a failure penalty value. “Y” is utilized in the pseudo-code 310 to update failure sums associated with query recommendations responsive to identifying that a displayable query recommendation 110 was not selected from a query recommendation box 111. “Y” may be configured small to minimize the penalty or large to maximize the penalty. Minimizing “Y” enhances exploration and diminishes exploitation. Accordingly, in some embodiments, “Y” may be configured as a small value to accommodate stationary devices (e.g., desktop computers) with large monitors for displaying query recommendations and ergonomic keyboards that facilitate typing. Alternatively, maximizing “Y” enhances exploitation and diminishes exploration. Accordingly, in some embodiments, “Y” may be configured as a large value to accommodate mobile devices (e.g., smartphone) with small monitors and small keyboards. In some embodiments, “Y” may be globally configured as a predetermined single value for all devices. In other embodiments, “Y” may be dynamically configured in real-time accordance with a device or a type of device that is communicating the query to the search server 108. In some embodiments “Y” may be an integer. In other embodiments “Y” may be real number.

The pseudo-code 310 is comprised of a selection summary pseudo-code 330 describing the updating of “FAILURE SUMS” and a “SUCCESS SUM” responsive to a displayable query recommendation 110 being selected from the query recommendation box 111 and a non-selection summary pseudo-code 340 describing updating “FAILURE SUMS” responsive to none of the displayable query recommendations 110 being selected from the query recommendation box 111.

The selection summary pseudo-code 330 includes two steps including the “First Step” (e.g., 1) and the “Second Step” (e.g., 2). The “First Step” describes updating a “SUCCESS SUM” for a query recommendation that was selected, and the “Second Step” describes updating a “FAILURE SUM” for each of the query recommendations that were not selected. The “First Step” adds “1” to the success sum. For example, assuming a “SUCCESS SUM” of “5” is associated with the displayable query recommendation “APPLE CLOUD,” and “APPLE CLOUD” is selected, then the first step is computed as “6=1+5” to compute a new “SUCCESS SUM” of “6” for the query recommendation “APPLE CLOUD.” The “Second Step” utilizes the variables “X” and “M” to compute a “FAILURE SUM” for each of the query recommendations that were not selected. For example, assuming “M” is “5” and “X” is 1, then a “FAILURE SUM” for each of the query recommendations that were not selected may be computed as follows in TABLE 1:

TABLE 1

| QUERY | OLD | | NEW |
|---|---|---|---|
| RECOMMENDATION | “FALURE | | “FAILURE |
| NOT SELECTED | SUM” | COMPUTE | SUM” |
| APPLE STORE | 20 | 20 + (1/(5 − 1)) | 20.25 |
| APPLE WATCH | 35 | 35 + (1/(5 − 1)) | 35.25 |
| APPLE NEWS | 11 | 11 + (1/(5 − 1)) | 11.25 |
| APPLE STOCK | 88 | 88 + (1/(5 − 1)) | 88.25 |

The non-selection summary pseudo-code 340 includes a step to update a “FAILURE SUM” for all of the displayable query recommendations responsive to identifying that none of the displayable query recommendations were selected. For example, assuming “M” is “5,” “X” is “1,” and “Y” is “2,” then a “FAILURE SUM” for each of the query recommendations that were not selected may be computed as follows in TABLE 2:

TABLE 2

| QUERY | OLD | | NEW |
|---|---|---|---|
| RECOMMENDATION | “FALURE | | “FAILURE |
| NOT SELECTED | SUM” | COMPUTE | SUM” |
| APPLE CLOUD | 20 | 20 + (1 * 2)/(5 − 1)) | 20.5 |
| APPLE STORE | 20 | 20 + (1 * 2)/(5 − 1)) | 20.5 |
| APPLE WATCH | 35 | 35 + (1 * 2)/(5 − 1)) | 35.5 |
| APPLE NEWS | 11 | 11 + (1 * 2)/(5 − 1)) | 11.5 |
| APPLE STOCK | 88 | 88 + (1 * 2)/(5 − 1)) | 88.5 |

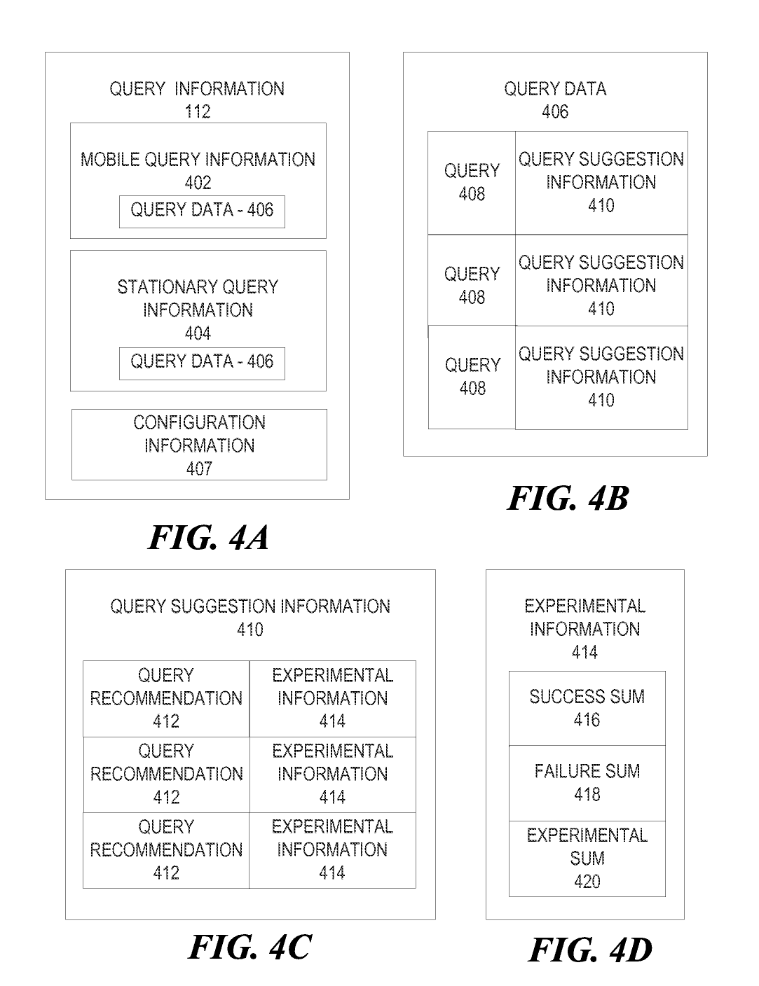

FIG. 4A is block diagram illustrating query information 112, according to an embodiment. The query information 112 may be utilized as previously described. The query information 112 may include mobile query information 402, stationary query information 404, and configuration information 407. The mobile query information 402 and stationary query information 404 both include query data 406 that is utilized to store the previously described success sums and failure sums. Accordingly, the query information 112 for mobile devices may be maintained independently from the query information 112 for stationary devices. The configuration information 407 may be utilized to associate a device (e.g., device type identifier, device identifier, etc.) with definitions 320 that were described in FIG. 3. In another embodiment the query information 112 may be stored according to users. For example, each user that enters a query that is processed may be associated with query information 112. In another embodiment the mobile query information 402 may be stored according to device or device type and the stationary query information 404 may be stored according to device or device type.

FIG. 4B is block diagram illustrating query data 406, according to an embodiment. The query data 406 may include multiple entries of a query 408 in association with query suggestion information 410. The processing module 120 may utilize the query data 406 to associate a query 408 that is received from a user with an entry of query suggestion information 410 by matching the received query 408 to the query 408 in the query data 406.

FIG. 4C is block diagram illustrating query suggestion information 410, according to an embodiment. The query suggestion information 410 may include multiple entries of a query recommendation 412 in association with experimental information 414, as previously described.

FIG. 4D is block diagram illustrating experimental information 414, according to an embodiment. The experimental information 414 may include a success sum 416 and a failure sum 418, as previously described, and also an experimental sum 420, which is utilized to count the number of experiments (e.g., the number of times the associated query recommendation 412 was presented to a user for possible selection). The processing module 120 may utilize the experimental information 414 to generate and sample the probability distributions. For example, the processing module 120 may pass the experimental information 414 to a statistical library function (e.g., probability distribution function ( )) that returns the probability distribution in the form of a histogram or some other mathematical representation or structure that includes data. Further, the processing module 120 may pass the probability distribution to a statistical library function (e.g., probability distribution sampling function ( )) that returns a probability. In some embodiments the probability distribution function may not utilize the experimental sum 420 but merely round the success sum 416 and the failure sum 418 to identify the number of trial or experiments.

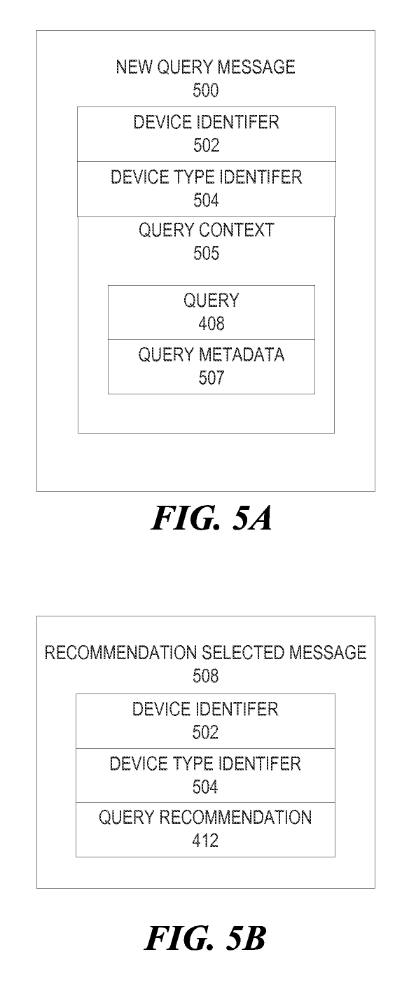

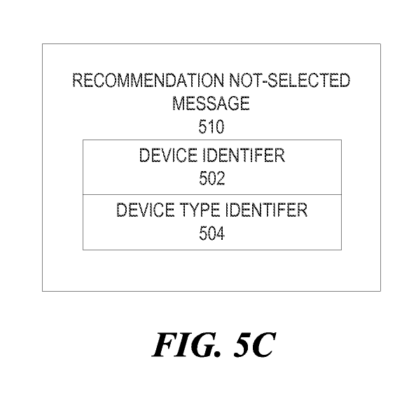

FIG. 5A is block diagram illustrating a new query message 500, according to an embodiment. The new query message 500 may be received by the search server 108 responsive to the user entering a query 408 into the input box 104. The new query message 500 may include a device identifier 502 that identifies the device that communicated the query 408, a device type identifier 504 that identifies a type of the device that communicated the query 408, and the query context 505. The query context 505 may include the query 408, as previously described, and query metadata 507. The query metadata 507 may describe a context of the query 408 thereby narrowing the scope of the query 408. For example the query metadata 507 may include a category that is utilized to narrow the scope of the query 408. Accordingly, the system 100 may utilize both the query 408 and the category to identify displayable query recommendations 110. Further for example, the query metadata 507 may include one or more parameters that narrow the scope of the query. Accordingly, the system 100 may utilize both the query 408 and the one or more parameters to identify displayable query recommendations 110. In some embodiments the system 100 may operate to identify displayable query recommendations 110 without a query 408 and solely based on the query metadata 507. For example, the query metadata 507 may not include a query 408 but nevertheless include a category that is utilized by the system 100 to identify displayable query recommendations 110. Further for example, the query metadata 507 may not include a query 408 but nevertheless include one or more parameters that are utilized by the system 100 to identify displayable query recommendations 110. Further for example, the query metadata 507 may not include a query 408 but nevertheless include a category and one or more parameters that are utilized by the system 100 to identify displayable query recommendations 110.

FIG. 5B is block diagram illustrating a recommendation selected message 508, according to an embodiment. The recommendation selected message 508 may be received by the search server 108 responsive to the user selecting a query recommendation 412 in the query recommendation box 111. The recommendation selected message 508 may include a device identifier 502, a device type identifier 504, and the query recommendation 412 that was selected, all as previously described.

FIG. 5C is block diagram illustrating a recommendation not-selected message 510, according to an embodiment. The recommendation not-selected message 510 may be received by the search server 108 responsive to a progression through a search operation without receiving a selection that identifies a displayable query recommendation 110. For example, a user may progress thorough a search operation without selecting a displayable query recommendation 110 by executing a search that utilizes a query 408 in the input box 104. The recommendation not-selected message 510 may include a device identifier 502 and a device type identifier 504, as previously described.

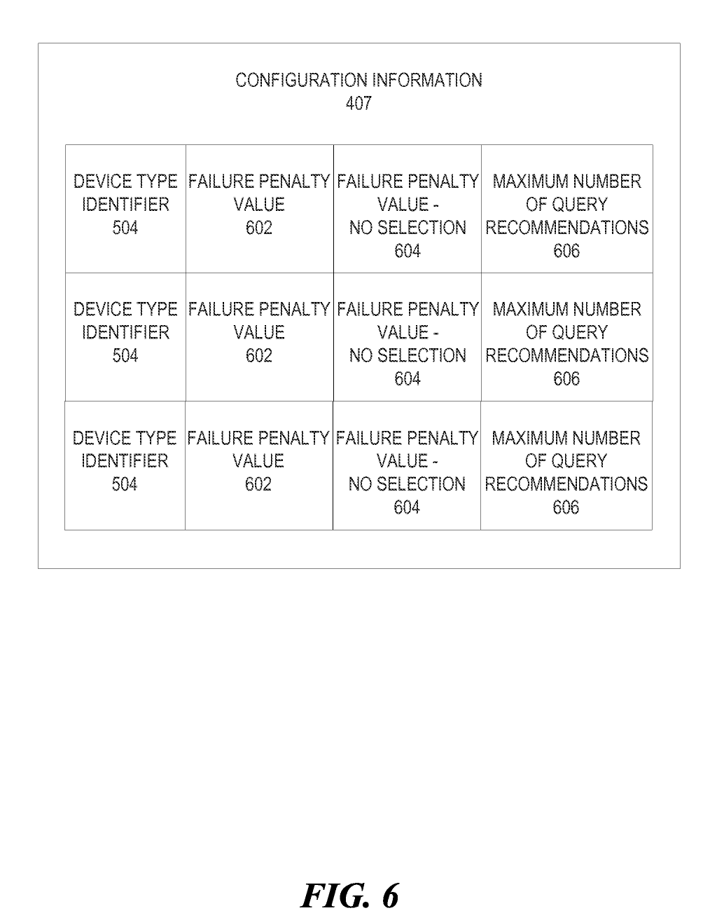

FIG. 6 is block diagram illustrating configuration information 407, according to an embodiment. The configuration information 407 may be utilized by the processing module 120 to associate a device (e.g., device type identifier 504) with definitions 320 of configurable parameters including a failure penalty value 602, a failure penalty value—no selection 604, and a maximum number of query recommendations 606, all as previously described. Other embodiments of the configuration information 407 may associate a device identifier 502 with the definitions 320.

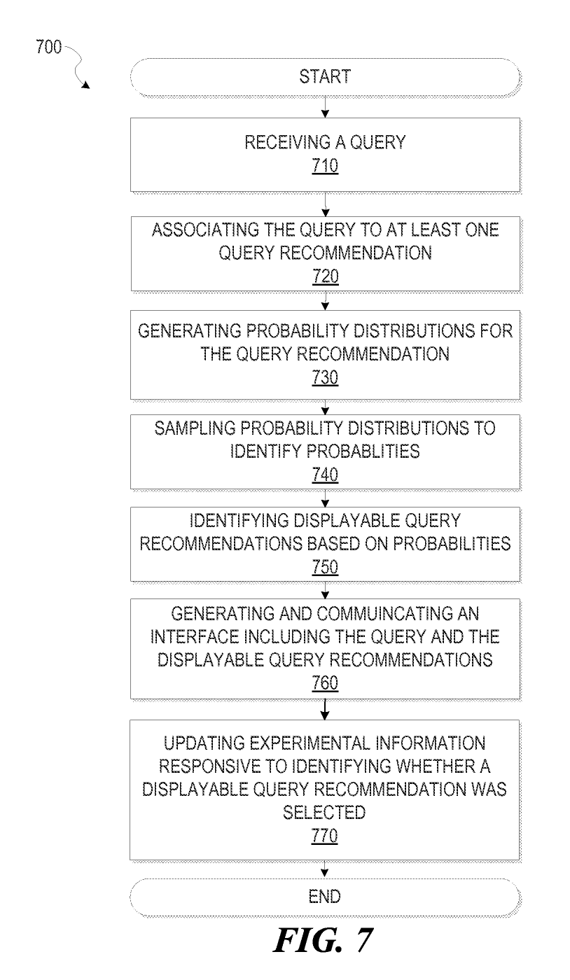

FIG. 7 is flow diagram illustrating a method 700, according to an embodiment, to identify query recommendations. The method 700 may commence at operation 710, with the receiving module 118, at the search server 108, receiving a new query message 500 over a network 106 from a client machine 102 (e.g., iPhone). At operation 720, the processing module 120 may utilize the query 506 (e.g., in the new query message 500) to identify query suggestion information 410 that includes one or more query recommendations 412. For example, the processing module 120 may execute steps comprising: 1) utilizing the device type identifier 504 in the new query message 500 to identify the client machine 102 is a mobile device; and 2) match the query 408 in the new query message 500 with the query 408 in the query data 406 in the mobile query information 402 to identify the query suggestion information 410.

At operation 730, the processing module 120 generates a probability distribution for each of the query recommendations 412 in the query suggestion information 410. To this end, the processing module 120 may generate the probability distributions based on the experimental information 414 that corresponds to each of the query recommendations 412. For example, the query suggestion information 410 may include three hundred query recommendations 412, and the processing module 120 may generate three hundred probability distributions based on the success sum 416, the failure sum 418, and the experimental sum 420 respectively associated with each of the query recommendations 412. That is, one probability distribution is generated based on the success sum 416, the failure sum 418, and the experimental sum 420 associated with a particular query recommendation 412.

At operation 740, the processing module 120 may randomly sample each of the probability distributions to yield a probability that corresponds to each of the query recommendations 412. For example, the processing module 120 may sample the three hundred probability distributions to identify three hundred probabilities that respectively correspond to each of the query recommendations 412.

At operation 750, the processing module 120 may identify displayable query recommendations 110 by sorting the probabilities from most to least likely to be selected and selecting a set of probabilities that are most likely to be selected. For example, assuming the maximum number of displayable query recommendations 606 is globally configured as the value “5,” then the processing module 120 may select the top “5” that are probabilities respectively associated with the “5” query recommendations 412 (e.g., “APPLE CLOUD,” “APPLE STORE,” “APPLE WATCH,” “APPLE NEWS,” “APPLE STOCK”). In some embodiments, the maximum number of displayable query recommendations 606 may be configured based on the device identifier 502 or the device type identifier 504 in the new query message 500. Accordingly, the processing module 120 may utilize the device identifier 502 or the device type identifier 504 to access the configuration information 407 to identify definitions 320 of configurable parameters, including the maximum number of displayable query recommendations 606.

At operation 760, the processing module 120 may generate an interface or information from which the device generates an interface including the query 408 and the displayable query recommendations 110 and communicate the interface and/or information to the client machine 102. For example, the processing module 120 may generate the user interface 116 including hypertext meta-language (HTML) elements and communicate the user interface 116 over the network 106 to the client machine 102. In another example, where the device has a dedicated application that needs only the information that will be displayed in an interface generated by the application, the processing module 120 sends the information in an appropriate format over the network 106 to the client machine 102 which then generates an appropriate user interface using the information.

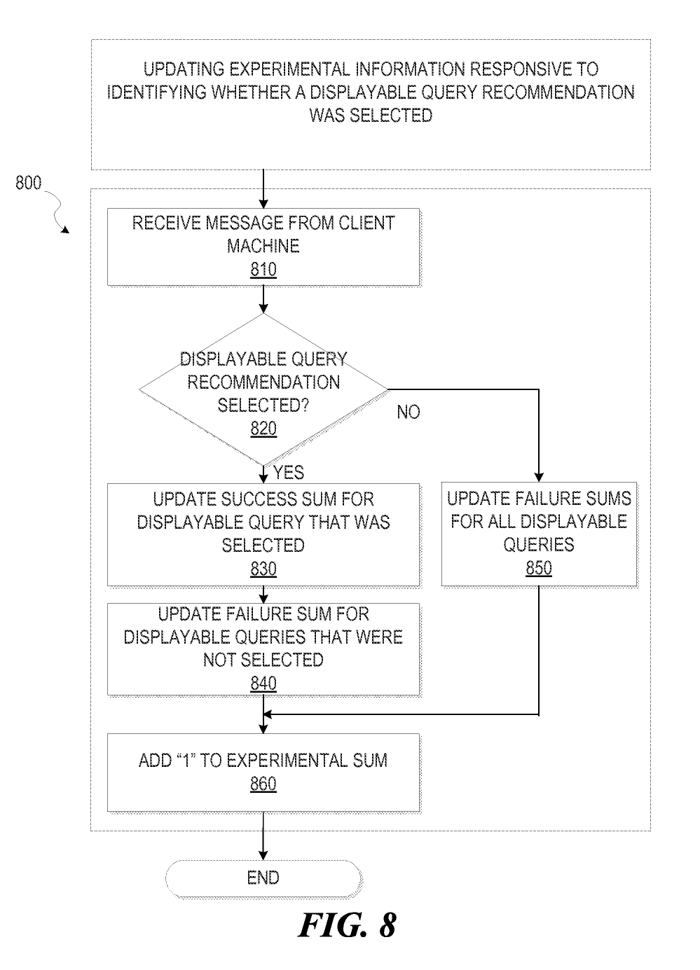

At operation 770, the receiving module 118 may receive a message that identifies whether a displayable query recommendation was selected or not-selected and update the experimental information 414 associated with each of the displayable query recommendations (e.g., “APPLE CLOUD,” “APPLE STORE,” “APPLE WATCH,” “APPLE NEWS,” “APPLE STOCK”) based on the message. For example, the message may include a recommendation selected message 508 that indicates a displayable query recommendation 110 was selected or a recommendation not-selected message 510 that indicates a displayable query recommendation 110 was not selected. The operation 770 is described more fully in FIG. 8.

FIG. 8 is flow diagram illustrating a method 800, according to an embodiment, to update experimental information 414. The method 800 may commence at operation 810 with the processing module 120 receiving a message from the client machine 102 (e.g., device). At decision operation 820, the processing module 120 may identify whether a displayable query recommendation 110 was selected. For example, if the processing module 120 identifies a recommendation selected message 508 was received (indicating that a displayable query recommendation 110 was selected), then a branch is made to operation 830. Otherwise, if the processing module 120 identifies a recommendation not-selected message 510 was received (indicating a displayable query recommendation 110 was not selected), then a branch is made to operation 850.

At operation 830, the processing module 120 may update the success sum 416 for the displayable query recommendation 110 that was selected in accordance with “Step 1” of the selection summary pseudo-code 330, as described in association with FIG. 3. For example, the processing module 120 may identify the displayable query recommendation 110 that was selected as identified in accordance with the query recommendation 412 included in the recommendation selected message 508.

At operation 840, the processing module 120 may update the failure sums 418 in accordance with “Step 2” of the selection summary pseudo-code 330, as described in association with FIG. 3. For example, the processing module 120 may identify the displayable query recommendations 110 that were not selected as determined by the query recommendation 412 included in the recommendation selected message 508.

At operation 850, the processing module 120 may update the failure sums 418 in accordance with the non-selection summary pseudo-code 340, as described in association with FIG. 3. For example, the processing module 120 may identify that no displayable query recommendations 110 were selected responsive to identifying receipt of the recommendation not selected message 510 and update the failure sums 418 for all of the displayable query recommendations 110.

At operation 860, the processing module 120 may update the experimental sum 420 for each of the displayable query recommendations 110. For example, the processing module 120 may add “1” to the experimental sum 420 associated with each of the displayable query recommendations 110.

According to one embodiment, the failure penalty value 602, the failure penalty value—no selection 604, and the maximum number of query recommendations 606 that are utilized by the pseudo-code 310 may be configured based on global values that are configured by an administrator. Accordingly, the global values may be predetermined in one embodiment. According to another embodiment, the failure penalty value 602, the failure penalty value—no selection 604, and the maximum number of query recommendations 606 may be dynamically configured based on the device identifier 502 or the device type identifier 504 included in a message including the new query message 500, the recommendation selected message 508, and the recommendation not selected message 510. For example, the processing module 120 may utilize the device identifier 502 or the device type identifier 504 to access the configuration information 407 and configure the failure penalty value 602, the failure penalty value—no selection 604, and the maximum number of query recommendations 606.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, engines, applications and so forth described in conjunction with FIGS. 1-8 are implemented in some embodiments in the context of multiple machines and associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here, as those of skill in the art can readily understand how to implement the disclosure in different contexts from the disclosure contained herein.

### Software Architecture

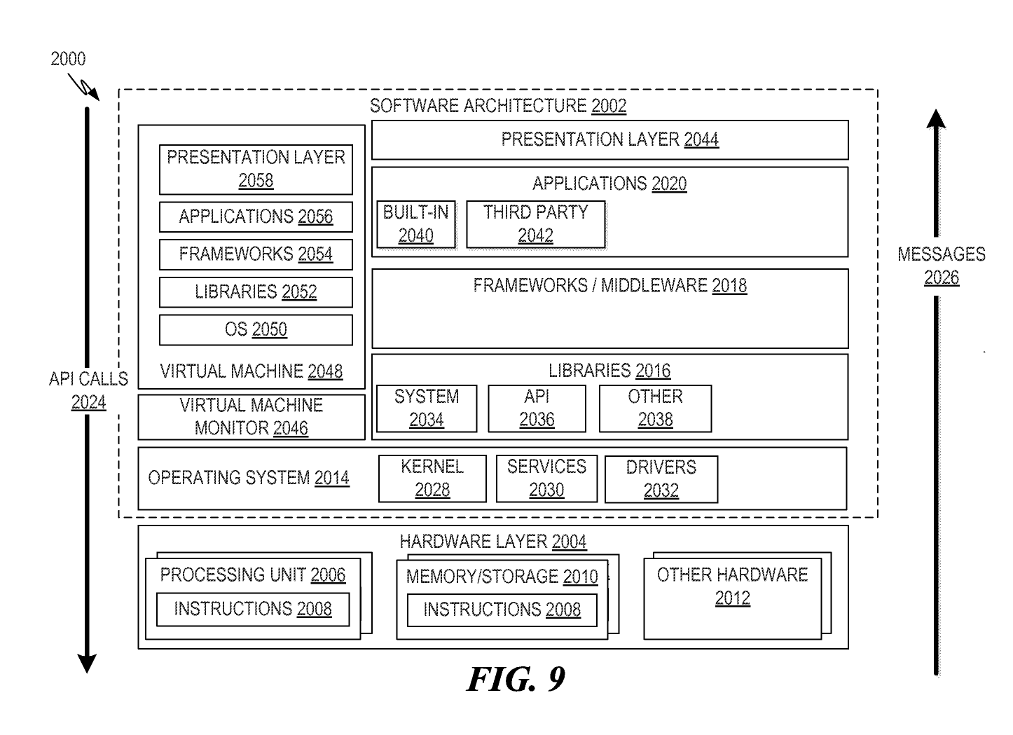

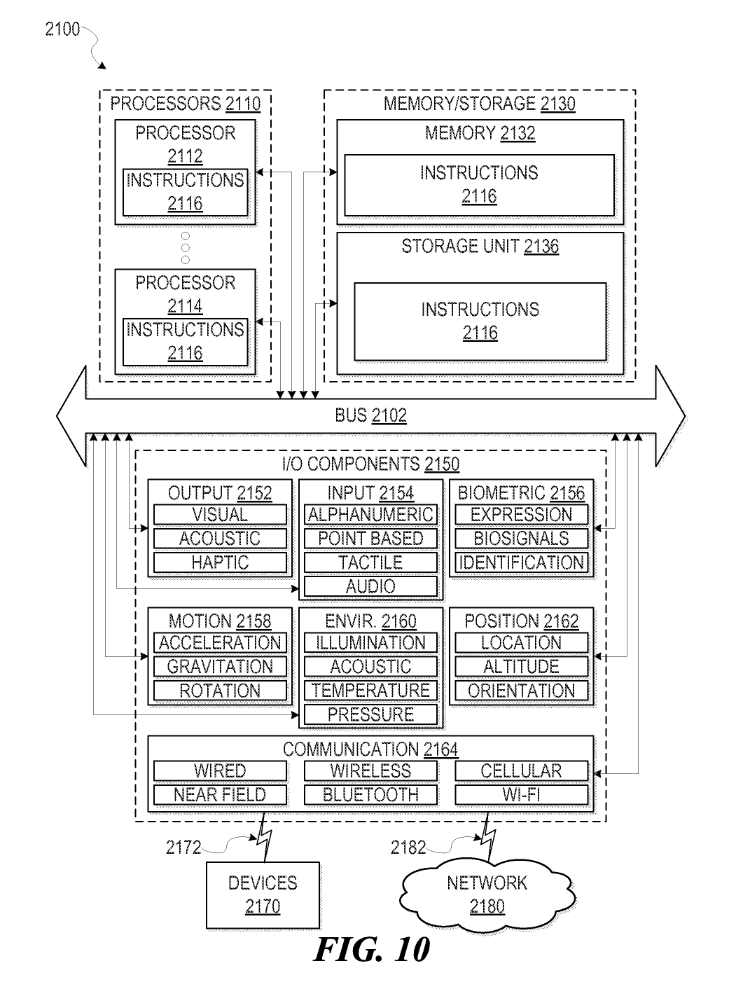

FIG. 9 is a block diagram 2000 illustrating a representative software architecture 2002, which may be used in conjunction with various hardware architectures herein described. FIG. 9 is merely a non-limiting example of a software architecture 2002 and it will be appreciated that many other architectures may be implemented to facilitate the functionality described herein. The software architecture 2002 may be executing on hardware such as machine 2100 of FIG. 10 that includes, among other things, processors 2110, memory 2130, and input/output (I/O) components 2150. Returning to FIG. 9, a representative hardware layer 2004 is illustrated and can represent, for example, the machine 2100 of FIG. 10. The representative hardware layer 2004 comprises one or more processing units 2006 having associated executable instructions 2008. Executable instructions 2008 represent the executable instructions of the software architecture 2002, including implementation of the methods, engines, modules and so forth of FIGS. 1-18. Hardware layer 2004 also includes memory and/or storage modules 2010, which also have executable instructions 2008. Hardware layer 2004 may also comprise other hardware, as indicated by 2012, which represents any other hardware of the hardware layer 2004, such as the other hardware 2012 illustrated as part of machine 2100.

In the example architecture of FIG. 9, the software 2002 may be conceptualized as a stack of layers where each layer provides particular functionality. For example, the software architecture 2002 may include layers such as an operating system 2014, libraries 2016, frameworks/middleware 2018, applications 2020, and presentation layer 2044. Operationally, the applications 2020 and/or other components within the layers may invoke API calls 2024 through the software stack and receive a response, returned values, and so forth, illustrated as messages 2026 in response to the API calls 2024. The layers illustrated are representative in nature and not all software architectures have all layers. For example, some mobile or special purpose operating systems 2014 may not provide a frameworks/middleware layer 2018, while others may provide such a layer. Other software architectures may include additional or different layers.

The operating system 2014 may manage hardware resources and provide common services. The operating system 2014 may include, for example, a kernel 2028, services 2030, and drivers 2032. The kernel 2028 may act as an abstraction layer between the hardware and the other software layers. For example, the kernel 2028 may be responsible for memory management, processor management (e.g., scheduling), component management, networking, security settings, and so on. The services 2030 may provide other common services for the other software layers. The drivers 2032 may be responsible for controlling or interfacing with the underlying hardware. For instance, the drivers 2032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2016 may provide a common infrastructure that may be utilized by the applications 2020 and/or other components and/or layers. The libraries 2016 typically provide functionality that allows other software modules to perform tasks in an easier fashion than to interface directly with the underlying operating system 2014 functionality (e.g., kernel 2028, services 2030, and/or drivers 2032). The libraries 2016 may include system 2034 libraries (e.g., C standard library) that may provide functions such as memory allocation functions, string manipulation functions, mathematic functions, and the like. In addition, the libraries 2016 may include API libraries 2036 such as media libraries (e.g., libraries to support presentation and manipulation of various media format such as moving picture experts group (MPEG) 4, H.264, MPEG-1 or MPEG-2 Audio Layer (MP3), AAC, AMR, joint photography experts group (JPG), portable network graphics (PNG)), graphics libraries (e.g., an Open Graphics Library (OpenGL) framework that may be used to render two-dimensional (2D) and two-dimensional (3D) in a graphic content on a display), database libraries (e.g., Structured Query Language (SQL) SQLite that may provide various relational database functions), web libraries (e.g., WebKit that may provide web browsing functionality), and the like. The libraries 2016 may also include a wide variety of other libraries 2038 to provide many other APIs 2036 to the applications 2020 and other software components/modules.

The frameworks 2018 (also sometimes referred to as middleware) may provide a higher-level common infrastructure that may be utilized by the applications 2020 and/or other software components/modules. For example, the frameworks 2018 may provide various graphic user interface (GUI) functions, high-level resource management, high-level location services, and so forth. The frameworks 2018 may provide a broad spectrum of other APIs 2036 that may be utilized by the applications 2020 and/or other software components/modules, some of which may be specific to a particular operating system 2014 or platform.

The applications 2020 include built-in applications 2040 and/or third party applications 2042. Examples of representative built-in applications 2040 may include, but are not limited to, a contacts application, a browser application, a book reader application, a location application, a media application, a messaging application, and/or a game application. Third party applications 2042 may include any of the built in applications as well as a broad assortment of other applications 2020. In a specific example, the third party application 2042 (e.g., an application developed using the Android™ or iOS™ software development kit (SDK) by an entity other than the vendor of the particular platform) may be mobile software running on a mobile operating system 2014 such as iOS™, Android™, Windows® Phone, or other mobile operating systems 2014. In this example, the third party application 2042 may invoke the API calls 2024 provided by the mobile operating system such as operating system 2014 to facilitate functionality described herein.

The applications 2020 may utilize built in operating system functions (e.g., kernel 2028, services 2030, and/or drivers 2032), libraries (e.g., system 2034, APIs 2036, and other libraries 2038), and frameworks/middleware 2018 to create user interfaces to interact with users of the system. Alternatively, or additionally, in some systems, interactions with a user may occur through a presentation layer, such as presentation layer 2044. In these systems, the application/module “logic” can be separated from the aspects of the application/module that interact with a user.

Some software architectures 2002 utilize virtual machines. In the example of FIG. 9, this is illustrated by virtual machine 2048. A virtual machine 2048 creates a software environment where applications/modules can execute as if they were executing on a hardware machine (such as the machine 2100 of FIG. 10, for example). A virtual machine 2048 is hosted by a host operating system (operating system 2014 in FIG. 21) and typically, although not always, has a virtual machine monitor 2046, which manages the operation of the virtual machine 2048 as well as the interface with the host operating system (i.e., operating system 2014). A software architecture 2002 executes within the virtual machine 2048 such as an operating system 2050, libraries 2052, frameworks/middleware 2054, applications 2056, and/or presentation layer 2058. These layers of software architecture 2002 executing within the virtual machine 2048 can be the same as corresponding layers previously described or may be different.

### Example Machine Architecture and Machine-Readable Medium

FIG. 10 is a block diagram illustrating components of a machine 2100, according to some example embodiments, able to read instructions from a machine-readable medium (e.g., a machine-readable storage medium) and perform any one or more of the methodologies discussed herein. Specifically, FIG. 10 shows a diagrammatic representation of the machine 2100 in the example form of a computer system, within which instructions 2116 (e.g., software, a program, an application, an applet, an app, or other executable code) for causing the machine 2100 to perform any one or more of the methodologies discussed herein may be executed. For example the instructions 2116 may cause the machine 2100 to execute the flow diagrams of FIG. 7 and FIG. 8. Additionally, the instructions 2116 may implement the receiving module 118 and the processing module 120 of FIG. 1, and so forth, including the modules, engines, and applications utilized in FIGS. 2-8. The instructions 2116 transform the general, non-programmed machine 2100 into a particular machine 2100 programmed to carry out the described and illustrated functions in the manner described. In alternative embodiments, the machine 2100 operates as a standalone device or may be coupled (e.g., networked) to other machines 2100. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 2100 capable of executing the instructions 2116, sequentially or otherwise, that specify actions to be taken by machine 2100. Further, while only a single machine 2100 is illustrated, the term “machine” shall also be taken to include a collection of machines 2100 that individually or jointly execute the instructions 2116 to perform any one or more of the methodologies discussed herein.

The machine 2100 may include processors 2110, memory 2130, and I/O components 2150, which may be configured to communicate with each other such as via a bus 2102. In an example embodiment, the processors 2110 (e.g., a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), another processor, or any suitable combination thereof) may include, for example, processor 2112 and processor 2114 that may execute instructions 2116. The term “processor” is intended to include multi-core processors 2112 that may comprise two or more independent processors 2112 (sometimes referred to as “cores”) that may execute instructions 2116 contemporaneously. Although FIG. 10 shows multiple processors 2112, the machine 2100 may include a single processor 2112 with a single core, a single processor 2112 with multiple cores (e.g., a multi-core process), multiple processors 2112 with a single core, multiple processors 2112 with multiples cores, or any combination thereof.

The memory/storage 2130 may include a memory 2132, such as a main memory, or other memory storage, and a storage unit 2136, both accessible to the processors 2110 such as via the bus 2102. The storage unit 2136 and memory 2132 store the instructions 2116, embodying any one or more of the methodologies or functions described herein. The instructions 2116 may also reside, completely or partially, within the memory 2132, within the storage unit 2136, within at least one of the processors 2110 (e.g., within the processor's cache memory), or any suitable combination thereof, during execution thereof by the machine 2100. Accordingly, the memory 2132, the storage unit 2136, and the memory of processors 2110 are examples of machine-readable media.

As used herein, “machine-readable medium” means a device able to store instructions 2116 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)) and/or any suitable combination thereof. The term “machine-readable medium” should be taken to include a single medium or multiple media (e.g., a centralized or distributed database, or associated caches and servers) able to store instructions 2116. The term “machine-readable medium” shall also be taken to include any medium, or combination of multiple media, that is capable of storing instructions (e.g., instructions 2116) for execution by a machine (e.g., machine 2100), such that the instructions 2116, when executed by one or more processors of the machine 2100 (e.g., processors 2110), cause the machine 2100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 2150 may include a wide variety of components to receive input, provide output, produce output, transmit information, exchange information, capture measurements, and so on. The specific I/O components 2150 that are included in a particular machine 2100 will depend on the type of machine. For example, portable machines 2100 such as mobile phones will likely include a touch input device or other such input mechanisms, while a headless server machine will likely not include such a touch input device. It will be appreciated that the I/O components 2150 may include many other components that are not shown in FIG. 10. The I/O components 2150 are grouped according to functionality merely for simplifying the following discussion and the grouping is in no way limiting. In various example embodiments, the I/O components 2150 may include output components 2152 and input components 2154. The output components 2152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 2150 may include biometric components 2156, motion components 2158, environmental components 2160, or position components 2162 among a wide array of other components. For example, the biometric components 2156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2158 may include acceleration sensor components (e.g., accelerometer), gravitation sensor components, rotation sensor components (e.g., gyroscope), and so forth. The environmental components 2160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 2162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2150 may include communication components 2164 operable to couple the machine 2100 to a network 2180 or devices 2170 via coupling 2182 and coupling 2172, respectively. For example, the communication components 2164 may include a network interface component or other suitable device to interface with the network 2180. In further examples, communication components 2164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 2170 may be another machine 2100 or any of a wide variety of peripheral devices (e.g., a peripheral device coupled via a USB).

Moreover, the communication components 2164 may detect identifiers or include components operable to detect identifiers. For example, the communication components 2164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2164, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 2180 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet 80, a portion of the Internet 80, a portion of the public switched telephone network (PSTN), a plain old telephone service (POTS) network, a cellular telephone network, a wireless network, a Wi-Fi® network, another type of network, or a combination of two or more such networks. For example, the network 2180 or a portion of the network 2180 may include a wireless or cellular network, and the coupling 2182 may be a Code Division Multiple Access (CDMA) connection, a Global System for Mobile communications (GSM) connection, or other type of cellular or wireless coupling. In this example, the coupling 2182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 2116 may be transmitted or received over the network 2180 using a transmission medium via a network interface device (e.g., a network interface component included in the communication components 2164) and utilizing any one of a number of well-known transfer protocols (e.g., hypertext transfer protocol (HTTP)). Similarly, the instructions 2116 may be transmitted or received using a transmission medium via the coupling 2172 (e.g., a peer-to-peer coupling) to devices 2170. The term “transmission medium” shall be taken to include any intangible medium that is capable of storing, encoding, or carrying instructions 2116 for execution by the machine 2100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “disclosure” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A system comprising:
a receiving module, implemented using one or more processors, that is configured to receive, over a network, a query from a device that is associated with a user; and
a processing module, implemented using one or more processors, that is configured to associate the query to at least one query recommendation, the processing module further configured to generate a probability distribution for each of the query recommendations, the probability distributions generated based on experimental information respectively associated with each of the query recommendations, the experimental information for each of the query recommendations including a success sum and a failure sum, the processing module further configured to sample each of the probability distributions to identify a probability for each the corresponding query recommendations, the probabilities respectively indicating the likelihood of the corresponding query recommendation being selected, the processing module is further configured to identify at least one query recommendation for display from the at least one query recommendation as at least one displayable query recommendation, the identification based on the probabilities for each the corresponding query recommendations and a maximum number of query recommendations, the processing module further configured to communicate an interface over the network to the device, the interface including the query and the displayable query recommendations, the processing module further configured to update experimental information associated with each of the displayable query recommendations, the processing module updates the experimental information responsive to an identification whether a displayable query recommendation was selected.

2. The system of claim 1, wherein the processing module is further configured to divide a failure penalty value by the maximum number of query recommendations and add the result to failure sums associated with each of the displayable recommendations responsive to an identification by the processing module that none of the displayable query recommendations were selected.

3. The system of claim 1, wherein the processing module is further configured to add one to a success sum associated with a displayable recommendation that was selected responsive to identification by the processing module that is configured to identify that a displayable query recommendation was selected.

4. The system of claim 1, wherein the processing module is further configured to divide a failure penalty value by the maximum number of query recommendations and add the result to failure sums associated with each of the displayable query recommendations that were not selected responsive identification by the processing module that a displayable query recommendation that was selected.

5. The system of claim 2, wherein the processing module configures the maximum number of displayable query recommendations based on the device associated with the user.

6. The system of claim 5, wherein the device is a mobile device; and
wherein the processing module is configured to identify a maximum number of displayable query recommendations based on a type of mobile device.

7. The system of claim 6, wherein the device is a stationary device; and
wherein the processing module is configured to identify a maximum number of displayable query recommendations based on a type of stationary device.

8. The system of claim 1, wherein the processing module is configured to configure a failure penalty value based on a device associated with the user.

9. The system of claim 8, wherein the processing module is configured to configure the failure penalty value based on a type of mobile device.

10. A computer implemented method comprising:
receiving, over a network, a query from a device that is associated with a user,
associating the query to at least one query recommendation;
generating a probability distribution for each of the query recommendations, the probability distributions being generated based on experimental information respectively associated with each of the query recommendations, the experimental information for each of the query recommendations including a success sum and a failure sum;
sampling each of the probability distributions to identify a probability for each the corresponding query recommendations, the probabilities respectively indicating the likelihood of the corresponding query recommendation being selected;
identifying at least one query recommendation for display from the at least one query recommendation as at least one displayable query recommendation, the identifying being based on the probabilities for each the corresponding query recommendations and a maximum number of query recommendations;
communicating an interface over the network to the device, the interface including the query and the displayable query recommendations; and
updating experimental information associated with each of the displayable query recommendations, the updating being responsive to identifying whether a displayable query recommendation was selected.

11. The method of claim 10, wherein the updating further includes dividing a failure penalty value by the maximum number of query recommendations and adding the result to failure sums associated with each of the displayable recommendations responsive to identifying that none of the displayable query recommendations were selected.

12. The method of claim, 10 wherein the updating further includes adding one to a success sum associated with a displayable recommendation that was selected responsive to identifying the displayable query recommendation as being selected.

13. The method of claim, 10 wherein the updating further includes dividing a failure penalty value by the maximum number of query recommendations and adding the result to failure sums associated with each of the displayable query recommendations that were not selected responsive to identifying a displayable query recommendation that was selected.

14. The method of claim 11, wherein the updating further includes configuring the maximum number of displayable query recommendations based on the device associated with the user.

15. The method of claim 14, wherein the device is a mobile device; and
wherein the maximum number of displayable query recommendations is identified based on a type of mobile device.

16. The method of claim 15, wherein the device is a stationary device; and
wherein the maximum number of displayable query recommendations is identified based on a type of stationary device.

17. The method of claim 10, wherein the updating further includes configuring a failure penalty value based on a device associated with the user.

18. The method of claim 17, wherein the device is a mobile device; and
wherein the failure penalty value is identified based on a type of mobile device.

19. A machine-readable medium having no transitory signals storing a set of instructions that, when executed by a processor, causes a machine to perform operations comprising:
receiving, over a network, a query from a device that is associated with a user,
associating the query to at least one query recommendation;
generating a probability distribution for each of the query recommendations, the probability distributions being generated based on experimental information respectively associated with each of the query recommendations, the experimental information for each of the query recommendations including a success sum and a failure sum;
sampling each of the probability distributions to identify a probability for each the corresponding query recommendations, the probabilities respectively indicating the likelihood of the corresponding query recommendation being selected;
identifying at least one query recommendation for display from the at least one query recommendation as at least one displayable query recommendation, the identifying being based on the probabilities for each the corresponding query recommendations and a maximum number of query recommendations;
communicating an interface over the network to the device, the interface including the query and the displayable query recommendations; and
updating experimental information associated with each of the displayable query recommendations, the updating being responsive to identifying whether a displayable query recommendation was selected.

20. The method of claim 19, wherein the updating further includes dividing a failure penalty value by the maximum number of query recommendations and adding the result to failure sums associated with each of the displayable recommendations responsive to identifying that none of the displayable query recommendations were selected.
